(19) United States
(12) Patent Application Publication
(10) Pub. No.: US 2009/0125408 A1
(43) Pub. Date: May 14, 2009

(54) Method of Buying and Selling Goods and/or Services

(76) Inventor: Denis McCarthy, Killorglin (IE)

Correspondence Address: BRINKS HOFER GILSON & LIONE, P.O. BOX 10395, CHICAGO, IL, 60610, US

(21) Appl. No.: 11/846,002

(22) Filed: Aug. 28, 2007

(51) Int. Cl. G06Q 30/00; G06Q 10/00; G06Q 20/00

(52) U.S. Cl. 705/26; 705/30; 705/28

(57) ABSTRACT

A method of buying and selling goods. A system administrator maintains an inventory of goods offered by participating merchants. A purchaser selects an item from the inventory and places an order for the selected item with an agent. The agent reports the order to the administrator and a unique transaction number is allocated to the order. The purchaser makes a payment for the item to the agent and the administrator debits a sum for the item from the agent. The administrator passes the order and transaction number to a merchant who makes the item available to a recipient, against the transaction number. The administrator credits the merchant with a sum for the item when it has been acquired by the recipient.

### FIELD OF THE INVENTION

The present invention relates to a method of conducting transactions which involves the buying and selling of goods and/or services. It is particularly, but not exclusively, concerned with purchasing an item in one country for supply in another country, even where the two countries may have different currencies.

At present, it is extremely difficult for an individual in one country to purchase goods for someone in another country, particularly if the first individual does not wish or is not able to use a credit card.

It is therefore an object of the invention to provide a method of conducting a transaction which allows such transactions to be conducted without difficulty. According to the invention, there is provided a method of doing business which comprises the steps of:

a system administrator maintaining an inventory of goods and/or services offered by participating merchants;

a purchaser selecting an item from the inventory and placing an order for the selected item with an agent;

the agent reporting the order to the administrator;

the purchaser making a payment for the item to the agent;

the administrator debiting a sum for the item from the agent;

the administrator passing the order to an appropriate participating merchant;

the merchant making the item available to a recipient; and

the administrator crediting the merchant with a sum for the item when it has been acquired by the recipient.

Thus, there are five distinct participants in this system, namely the purchaser of the item, the recipient of the item, the agent through whom the purchaser purchases the item, the system administrator who controls the business and settles the transaction, and the merchant who receives the order and provides the item to the recipient. It is to be understood that these five participants are not necessarily individuals, though the purchaser and recipient may well be, the agent, merchant and particularly the administrator are likely to be organisations.

Preferably, a unique transaction number is allocated to the order, and this may be passed to the merchant along with the order. Preferably, the transaction number is allocated by the administrator and is communicated to the agent and the purchaser. Preferably, the agent has an agreed payment channel to the administrator, and preferably also an internet connection to the administrator. Preferably the item is made available to the recipient against the transaction number.

Preferably, the administrator has the capability to track the inventory of items offered and subtract one item from the inventory if a potential purchaser in any agency selects an item. It also preferably has the ability to re-add this item to inventory if the potential purchaser does not follow through with the purchase. Preferably, the administrator issues up to date exchange rates to agencies for transactions involving more than one currency, and debits an agent's account each day for the value of all transactions carried out by the agent that day. Preferably, the administrator issues statements to agents on a regular basis and allows the merchants to change the status of an order to “completed” once the merchant has delivered the order. Preferably, therefore the method further includes the step of the merchant reporting acquisition of the item by the recipient to the administrator. The administrator preferably also issues statements to the merchants.

The method may include the steps of: the purchaser identifying details of the recipient to the agent; the agent passing the details to the administrator; and the administrator passing the details to the merchant. The method may further include the step of the merchant despatching the item to the recipient or advising the recipient that the item is available. Preferably, the merchant is able to add new goods to the system—including pictures for the inventory. Preferably, the merchant is able to transfer images of goods either from a CD ROM, a digital camera or the internet to the system. Preferably, the merchant can maintain a listing of the relevant goods on the inventory. Only the merchant should be able to manipulate the inventory of stock available to purchasers. The administrator preferably has the power to subtract one from the inventory once a potential purchaser makes an order e.g. by printing off an order form.

The system according to the invention can be used when the agent and the merchant are in different countries, even when the different countries have different currencies. This means that it is possible for the purchaser to pay the agent in the local currency of the purchaser and the merchant to be credited in the local currency of the merchant.

Preferably, the agent provides facilities for purchasers to browse the inventory maintained by the administrator. Preferably, therefore, the agent has access to either a call centre or a web site to enter the details of the recipient. Preferably, the method further includes the step of the agent issuing a receipt to the purchaser.

The purchaser may also enter his own details on the system via a touch screen interface located in the premises of the agent.

Preferably, the administrator keeps track of money in an escrow account for items ordered by the purchaser but not yet acquired by the recipient. Preferably, therefore, the administrator has the ability to handle and account for the foreign exchange of money in escrow from the agent's currency to the currency of the merchant.

The invention may be carried into practice in various ways and one embodiment will now be described by way of example.

A father in Madrid (Spain) wishes to buy his daughter in Santiago (Chile) a washing machine. He does not want to send her the money for security reasons and also in case she spends it on something else, and in any event Chilean Pesos are difficult to obtain in Madrid and Euros are difficult to change in Santiago. The system of the present invention provides a solution.

The father visits a system agent where he browses an inventory of white goods maintained by the system administrator. The inventory is displayed as a catalogue pictorially on a monitor screen, as the agent has an internet connection to the administrator. The father selects a machine and completes an order form which he passes to the agent, and then pays the agent for the machine in Euros.

The agent informs the administrator via the internet connection. The administrator confirms the order, issues a unique transaction number and removes one of the selected machines from the inventory. The transaction number is passed back to the agent and so to the father, together with details of the system-participating merchant in Santiago.

The administrator also advises the system-participating merchant in Santiago of the purchase, giving him the transaction number.

At the end of the day, the administrator batches the day's transactions and debits the account of the agent in Madrid (along with all other agents) a total amount for the day, which includes the appropriate sum for the father's washing machine.

The father contacts his daughter in Santiago, giving her the transaction number and details of the merchant in Santiago. The daughter arranges delivery with the merchant against the transaction number. After delivery, the merchant advises the administrator, who reimburses the merchant in Pesos (or any other currency he may choose).

Thus, the father pays in Euros for a washing machine which is delivered to his daughter in Santiago by a merchant who is paid in Pesos.

1. A method of conducting a transaction involving a purchaser, a recipient, one from a plurality of participating agents, one from a plurality of participating merchants, and an administration centre, wherein the method comprises the steps of:
maintaining an inventory of items offered by participating merchants at the administration centre;
the purchaser selecting an item from the inventory and placing an order for the selected item with an agent selected from the plurality of participating agents;
the selected agent reporting the order to the administration centre;
the purchaser making a payment for the selected item to the selected agent;
the administration centre debiting a purchase sum for the selected item from the selected agent;
the administration centre passing the order to a selected participating merchant;
the selected merchant making the selected item available to the recipient; and
the administration centre crediting the selected merchant with a retail sum for the selected item when it has been acquired by the recipient.

2. A method as claimed in claim 1, wherein that a unique transaction number is allocated to the order.

3. A method as claimed in claim 2, wherein that the transaction number is allocated by the administration centre.

4. A method as claimed in claim 3, wherein that the transaction number is communicated to the selected merchant along with the order.

5. A method as claimed in claim 3, wherein the transaction number is communicated to the selected agent and to the purchaser.

6. A method as claimed in any preceding claim 1, the further steps of:
the purchaser identifying details of the recipient to the selected agent;
the selected agent passing the recipient details to the administration centre; and
the administration centre passing the recipient details to the selected merchant.

7. A method as claimed in claim 6, comprising the further step of the selected merchant despatching the selected item to the recipient.

8. A method as claimed in claim 6, advising the recipient that the selected item is available.

9. A method as claimed in claim 2, wherein the selected item is made available to the recipient against the transaction number.

10. A method as claimed in claim 1, comprising the further step of the selected merchant reporting acquisition of the item by the recipient to the administration centre.

11. A method as claimed in claim 1, wherein the selected agent and the selected merchant are in different countries.

12. A method as claimed in claim 10, wherein the different countries have different currencies.

13. A method as claimed in claim 12, wherein the purchaser pays the selected agent in the local currency of the purchaser and the selected merchant is credited in the local currency of the selected merchant.

14. A method as claimed in claim 1, wherein the participating agents provide facilities for a purchaser to browse the inventory maintained by the administration centre.

15. A method as claimed in claim 1, comprising the further step of the selected agent issuing a receipt to the purchaser.

16. A method as claimed in claim 1, wherein that the administration centre keeps track of sums of money in an escrow account in respect of selected items ordered by the purchaser but not yet acquired by the recipient.
